(19) United States
(12) Patent Application Publication
(10) Pub. No.: US 2022/0035505 A1
(43) Pub. Date: Feb. 3, 2022

(54) DEVICE, ITS USE AND SYSTEM FOR GENERATING A PERIODIC SIGNAL ON A CAPACITIVE SURFACE SENSOR

(71) Applicant: Prismade Labs Gmbh, Chemnitz (DE)

(72) Inventors: Karin Weigelt, Chemnitz (DE); Jan Thiele, Chemnitz (DE)

(73) Assignee: Prismade Labs Gmbh, Chemnitz (DE)

(21) Appl. No.: 17/276,259

(22) PCT Filed: Sep. 17, 2019
(86) PCT No.: PCT/EP2019/074783

§ 371 Date: Mar. 15, 2021

(30) Foreign Application Priority Data
Sep. 17, 2018 (EP) 18000747.8
Mar. 21, 2019 (EP) 19164305.5

(51) Int. Cl. G06F 3/041; G06F 3/044

(52) U.S. Cl. CPC G06F 3/04166; G06F 3/0442

(57) ABSTRACT

The invention relates to a device and a system for generating a periodic signal on a capacitive surface sensor, as well as the use of the device for generating a periodic signal on a capacitive surface sensor. The device is formed by a three-dimensional object, on at least the contact side of which an electrically conductive structure is arranged. The system comprises such a device, as well as a capacitive surface sensor, wherein the device can be used for generating periodic signals on the surface sensor.

The invention relates to a device and a system for generating a periodic signal on a capacitive surface sensor, as well as to the use of the device for generating a periodic signal on a capacitive surface sensor. The device is formed by a three-dimensional object, on at least the bottom side of which an electrically conductive structure is arranged. The system comprises such a device, as well as a capacitive surface sensor, wherein the device can be used for generating periodic signals on the surface sensor.

### State of the Art

In 2010, data carriers were disclosed for the first time that can be read by capacitive touchscreens such as those found in commercially available smartphones and tablets. The following state of the art has since developed in this area:

WO 2011 154524 A1 describes a system for transmitting information from an information carrier to a capacitive surface sensor. The information carrier has an electrically conductive layer on an electrically non-conductive substrate, the electrically conductive layer being designed as a “touch structure” and comprising at least one touch point, a coupling surface and/or a conductor track. The touch points replicate the characteristics of fingertips. In addition to the system, the use of the system is described, as well as a method for the acquisition of information based on a static or dynamic interaction between the surface sensor and the information carrier. FIG. 20a-c of WO 2011 154524 A1 shows a variant of the interaction in which the device comprising the surface sensor is moved over the information carrier and the complete information of the information carrier is gradually read out. The document discloses the coding of the information, which is based in particular on the positions of the sub-regions.

WO 2012 072648 A1 describes a method for capturing information from an information carrier using a capacitive touch screen. The application relates essentially to a system similar to the aforementioned prior art. The described information carrier consists essentially of two different materials that differ in terms of conductivity or dielectric coefficient. Relative movement between the information carrier and the touch screen causes an interaction between the information carrier and the surface sensor, based on the different material properties, which generates a touch signal. Likewise in this document, the electrically conductive pattern includes the basic elements of touch points, coupling area and conductive traces, where the conductive traces connect the touch points to each other and/or to the coupling area.

WO 2016 131963 A1 describes a capacitive information carrier comprising first and second electrically conductive regions that are at least partially connected to each other. At least two subregions of the first electrically conductive region cover at least two different intersections of transmitting and receiving electrodes of the touchscreen.

All of the above applications commonly have the basic idea of using the electrically conductive structure, which is arranged on an information carrier, to simulate the properties of fingertips and thus enable the information carriers to be read out on capacitive touchscreens. Since corresponding touchscreens were thus used “for purposes other than intended,” it was necessary to adapt the electrically conductive structures to such an extent that the touchscreen could perceive corresponding inputs through the electrically conductive structure and not “filter them out.” The basic idea in the prior art documents is based on geometric coding, in which the relative position of the electrically conductive elements of the electrically conductive structures among each other essentially forms the basis of the coding/decoding.

WO 2018 141478 A1 describes a method for generating a time-dependent signal on a capacitive surface sensor whose conductive structure consists of many individual elements and wherein a time-dependent signal is generated by a relative movement between an input means and the card-like object. WO 2018 141479 A1 discloses a device for generating a time-dependent signal on a capacitive surface sensor. Both applications necessitate the provision of an input means that is in dynamic operative contact with the electrically conductive structure. The need for an input means may be disadvantageous for certain applications.

The objective of the present invention is to provide a device and a system for generating a periodic signal on a capacitive surface sensor that does not exhibit the disadvantages and shortcomings of the prior art. Furthermore, the device to be provided is intended to cause a periodic signal to be generated on the surface sensor without the need for additional input means. A further objective underlying the invention is to provide a particularly user-friendly interactive device which can be used for purposes of verification, authentication and/or identification.

### DESCRIPTION OF THE INVENTION

The objective is solved by the features of the independent claims. Advantageous embodiments of the invention are described in the dependent claims.

According to the invention for solving the problem, a device for generating a periodic signal on a capacitive surface sensor is preferably provided, wherein the device comprises an electrically conductive structure which is present arranged on a non-conductive substrate. The device is characterized in that the device is a three-dimensional object, the three-dimensional object having a bottom side, the electrically conductive structure being present arranged at least on the bottom side of the three-dimensional object and defining the course of a periodic signal.

In particular, the invention further relates to a device for generating a periodic signal on a capacitive surface sensor having an electrode grid comprising rows and columns, wherein the device is a three-dimensional object, wherein the three-dimensional object has a contact surface, wherein an electrically conductive structure is present at least on the contact surface of the three-dimensional object, and wherein the electrically conductive structure is arranged such that, upon movement of the device relative to the surface sensor along the direction of a row or a column of the electrode grid, a periodic signal is generated which oscillates orthogonally to the movement of the device.

In another aspect, the invention preferably relates to a system comprising the device as well as apparatus comprising a surface sensor.

Thus, the invention preferably further relates to a system for generating a periodic signal on a capacitive surface sensor, the system comprising a device as well as an apparatus comprising a capacitive surface sensor, wherein
a) the device is a three-dimensional object, the three-dimensional object having a contact surface, wherein an electrically conductive structure is disposed at least on the contact surface (50) of the three-dimensional object
b) the capacitive surface sensor has an electrode grid comprising rows and columns,
   and wherein the electrically conductive structure is arranged such that, upon movement of the device relative to the surface sensor substantially along the direction of a row or a column of the electrode grid, a periodic signal is generated which oscillates orthogonally to the movement of the device. The inventors have found that there is a relationship between the specific structure of the electrically conductive elements on the device, or their arrangement relative to each other, and the course of a periodic signal on the surface sensor when a relative movement of the device on the surface sensor is performed.

The signal in the sense of the invention is preferably understood as the spatial course of the input on a touch surface or a screen of a surface sensor, which is perceived by the surface sensor or its touch controller. The touch surface preferably designates that outer surface of a surface sensor which is provided for an input in the form of a touch. In the case of a touchscreen as a surface sensor, the touch surface is the screen.

When a user moves a finger over the touch surface or the screen of a surface sensor, said movement of the finger is detected by the surface sensor as a spatial signal, with the course of this spatial signal essentially corresponding to the course of the finger movement.

The movement of the user's finger or the signal perceived by the surface sensor can, for example, be recorded by the surface sensor in a coordinate system with two axes (and, if necessary, displayed on a screen), which, according to mathematical conventions, are designated x-axis for the horizontal axis and y-axis for the vertical axis. Thus, a change in the x-coordinate preferably corresponds to a shift of a point to the right or left, while a change in the y-coordinate of a point corresponds to a shift up or down. When a user finger moves across a touch surface or the screen of a surface sensor, the actual movement and the signal detected by the surface sensor substantially correspond.

When a device having an electrically conductive structure is moved across a touch surface or screen of a surface sensor, the motion sensed and detected by the surface sensor does not necessarily correspond to the motion of the device on the touch surface or screen, but rather the detected signal is altered by the electrically conductive structure relative to the actual motion of the device, said alteration preferably being referred to as a deviation or distortion in the sense of the invention. It is a significant merit of the present invention that the proposed device can be used to provide input on a capacitive surface sensor without requiring the use of any specific input means.

This means that the requirement for an input device, which is otherwise common and recognized in the state of the art, can be dispensed with, enabling particularly user-friendly and simple operation of a surface sensor or use of a system consisting of a surface sensor and a device.

The advantages of not having to use the input means are, for example, that the user no longer has to use his finger to make an input on the surface sensor. This may be desirable to allow for an easier use of the device.

The user may hold the device in one hand, which contains the surface sensor, and use the other hand to guide the device over the surface sensor. The method of using the device is advantageous because it is very intuitive for the user to bring the device and the apparatus (comprising the surface sensor) together in this simple manner. Not having to use an input device may also be advantageous because it avoids forgetting or losing input devices, such as stylos or special pens.

In particular, when the proposed device is used with the surface sensor as a system, use of the device is facilitated by the fact that, in the context of the present invention, the device “simply” needs to be pulled over the surface sensor without the need to accompany, track, or assist said pulling movement with any input means or the like.

The pulling movement of the three-dimensional object is preferably also referred to as a “relative movement” between the device and the surface sensor in the sense of the invention. Compared to the prior art, the device according to the invention advantageously enables a particularly intuitively operable and user-friendly interactive object, which can be verified and/or identified with the aid of a capacitive surface sensor.

If, as described above, an xy coordinate system is mentally placed on a contact surface or the screen of a surface sensor, different progressions result for the actual movement of the device and the signals detected by the surface sensor, the deviations being due in particular to the presence of the electrically conductive structure. The orientation of the xy coordinate system preferably corresponds to the orientation of an electrode grid of the surface sensor.

The inventors have recognized that when relative motion is performed between a device having a suitable electrically conductive structure and a surface sensor, a periodic signal is generated which manifests itself in a mentally placed xy-coordinate system as described above, particularly as a wobble, loop or zigzag pattern. In other words, the signal detected by the surface sensor “oscillates” around a fixed center position, with the downward or upward deviations being referred to as “amplitudes”.

To this end, it is preferred that movement of the device relative to the surface sensor be substantially along the direction of a row or column of the electrode grid. The electrical structure is arranged or configured such that the surface sensor thereby detects a periodic signal that oscillates orthogonally to the movement of the device.

It is preferred in the spirit of the invention that the terms “oscillate”, “swing” or “wobble” be used interchangeably. In particular, the mental coordinate system can be placed on the screen of the surface sensor such that the x-axis of the coordinate system coincides with the fixed center position around which the periodic signal oscillates. The course of the periodic signal can then advantageously be represented as a function x(y), whereby it is preferred in the sense of the invention that this function x(y) exhibits a periodicity.

The y-direction preferably corresponds to the movement of the device, while the x-direction defines a direction orthogonal to it, in which the signal oscillates about a center position.

It is preferred in the sense of the invention that the terms “repeating”, “repetitive”, “recurring at intervals” or “cyclic” are used synonymously with the term “periodic” and with each other. The periodicity described herein in connection with the mental coordinate system is preferably referred to as spatial periodicity for the purposes of the invention.

It may also be preferred in the sense of the invention that the periodic signal has a periodicity with respect to time. In this context, the x-coordinate and/or the y-coordinate of the periodic signal may be represented respectively as a function of time, that is, as a function of the x-coordinate x(t) and as a function of the y-coordinate of the periodic signal y(t). In this context, the periodic signal represents a temporally periodic change in magnitude, whereas in the previously described case it represents a spatially periodic change in magnitude, in which spatially varying magnitudes are preferably described. It is preferred in the sense of the invention that the periodic signal generated in the context of the present invention is moreover time-dependent. The skilled person will recognize that the representations of the periodic signal as a spatially or temporally periodic change are convertible into each other. In a spatial representation x(y), the y-coordinate preferably defines the course of movement of the device on the surface sensor. In a temporal representation x(t) the t-coordinate preferably defines the temporal course during the movement of the device on the surface sensor. Knowing y(t), i.e. the temporal movement of the device on the surface sensor, the two representations can be transformed or converted into each other.

The temporal periodicity is preferably characterized by the period duration of the signal. In particular, it is a dynamic signal, which in the sense of the present invention is intended to mean in particular that the periodic signal changes while the device is moved over the surface sensor, i.e. during the relative movement between the electrically conductive structure and the surface sensor. In particular, it is preferred in the sense of the invention that the electrically conductive structure acts or functions as a signal generator.

The electrical structure is preferably configured in such a way that when the device moves relative to the surface sensor, a periodic signal is generated which oscillates orthogonally to the movement of the device.

It is further preferred in the sense of the invention that the course of the periodic signal is influenced or determined in particular by the centroid (i.e. geometric center) of the electrically conductive structure or by sub-regions of the electrically conductive structure. In particular, it is preferred that the centroid of sub-regions interacts with the electrode grid of the capacitive surface sensor. In other words, it may be particularly preferred that the centroid overlaps with selected electrode intersections and thus interacts at this location. For example, the area centroid of the electrically conductive structure may be formed by the geometric centroid of the area covered by the electrically conductive structure. It may also be preferred that each sub-element together with the main element form a centroid (i.e. geometric center of the respective areas). However, it may also be preferred that the centroid of the electrically conductive structure is influenced by the mass distribution and/or area coverage of the electrically conductive material forming the electrically conductive structure, so that a weighted centroid of the electrically conductive structure can be determined.

In a preferred embodiment, the electrically conductive structure has at least two subregions with two centroids, which are arranged to generate a touch event in the case of superimposition with an intersection of the electrode grid and to generate no touch event in the case of no superimposition with an intersection of the electrode grid, so that, during a relative movement of the device along a row or column of the electrode grid, a periodic signal is generated by alternate generation of a touch event in the case of alternate superimposition of the first or second centroids with intersections of the electrode grid.

The centroid is preferably a geometric center that can be determined with respect to a sub-region. If the centroid of that sub-region overlaps with an electrode intersection of the surface sensor, the electrode intersection is preferably covered by a sufficient portion or area of the electrically conductive structure so that a touch event is triggered.

As explained in detail below, the detection of touch events in capacitive surface sensors is based on capacitive interaction, wherein commercial surface sensors, in particular touch screens, are optimized for the detection of fingertips. A touch event is to be generated by the surface sensor only when a sufficiently capacitive interaction is recorded by means of its electrode grid, which indicates a finger touch. In the prior art, such as WO 2011154524 A1, the realization was exploited to emulate fingertips with conductive touch points. For these to be effectively detected when positioned on a touch screen, the touch points should preferably be of sufficient size (preferably with a diameter of 8 mm or more) and/or additionally capacitively charged by coupling an external capacitance (for example, a hand).

The electrically conductive structure according to the invention preferably does not provide such touch points. Instead, the preferably at least two sub-regions with two different centroids are not intended to be detected as two touch events at any positioning on a surface sensor. In particular, the two surface centroids are not intended to result in stable touch events such that movement of the device over the surface sensor is detected as a continuous touch move.

Rather, it is preferred that the subregions of the electrically conductive structure do not completely fill an area corresponding to an electrode intersection (i.e., for example, 5×5 mm). Rather, it is preferred that the subregions have a dimension that spans two, four or more electrode intersections, but do not completely fill the area of two, four or more electrode intersections.

Instead, it may be preferred that the subregions are configured such that, at a position where the centroid of the area does not overlap with an electrode intersection, no area on any electrode intersection is covered with sufficient electrically conductive material to trigger a touch event.

When the centroid of the area does not overlap with an electrode intersection, it is preferred that the substantial area of the sub-region of the structure be divided between at least two electrode intersections such that there is insufficient capacitive interaction for the electrode intersection to trigger a touch event. For example, it may be preferred that in such a position, less than 20%, preferably less than 10% of the area of an electrode intersection is covered by the sub-region.

On the other hand, as soon as a centroid of the surface of the sub-regions overlaps with an electrode intersection, it is preferred that there be sufficient coverage of the electrode intersection with electrically conductive material to establish a capacitive interaction that triggers a touch event.

The at least two sub-regions with the two (area) centroids can preferably be present at the distance of one row or column of the electrode grid (or an integer multiple thereof), whereby it is particularly preferred that the surface foci are located at different heights in the intended direction of movement of the device.

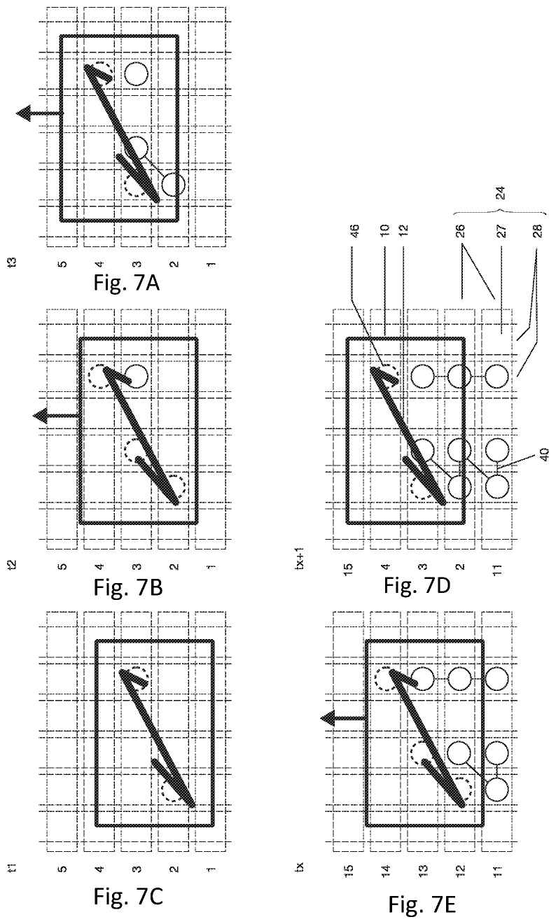

FIG. 7 shows an example of an electrically conductive structure with a linear main element and a linear left-hand sub-element which is arranged at an angle to the main element. The sub-element and main element in the left-hand region can be divided mentally into two sub-regions in relation to the underlying electrode grid, which have different centroids. During a movement along the direction of the columns, a touch event is generated in a left or right column depending on which (area) centroid overlaps with the electrode intersection. In other words, a touch event is generated in a left or right column when the respective electrode intersection of the underlying electrode grid is covered or overlapped by a minimum area of the electrically conductive structure. This relative minimum area is preferably >20% of the area of an electrode intersection and particularly preferably >30% of the area of an electrode intersection.

According to the invention, various electrically conductive structures are conceivable, which lead to alternate generation of touch events during a relative movement along the direction of a row or column.

Electrically conductive structures with a linear shape have proven to be particularly preferred. Preferably, the electrically conductive structures are formed by a continuous line, wherein the line can preferably have angles and/or curves.

The linear shape herein preferably has a width of 0.5 mm to 8 mm, preferably 1.5 mm to 5 mm, particularly preferably 1.5 mm to 3 mm.

Particularly preferably, the electrically conductive structure does not comprise any sub-regions which have an extension of 8 mm×8 mm or more. In the case of such sub-regions, as known from the prior art, touch events of said dimension can at any point be triggered, preferably independently of an overlap of a centroid with an electrode intersection. In other words, it is preferred that the electrically conductive structure is designed such that it does not completely cover or overlap any of the electrode intersections of the underlying electrode grid at any time when the device is moved over the capacitive surface sensor. The preferred relative maximum area is <70% of the area of an electrode intersection, and particularly preferably <50% of the area of an electrode intersection.

By means of a line shape, a dependence of the generation of touch events on a relative position to the electrode intersection and thus a described generation of an oscillating signal can be achieved in a particularly effective way.

It is preferred in the sense of the invention to characterize the electrically conductive structure by the design of at least one main element. It is further preferred that the electrically conductive structure can additionally be characterized by the design of at least one sub-element. For the purposes of the invention, the term design includes, but is not limited to, shape, size, geometry, length, width, orientation, position, and angle of the element of the electrically conductive structure. Preferred design variations include, for example, linear main and/or sub-elements characterized by length, width and angle. It is preferred that the sub-elements are galvanically connected to the main element and in their entirety form the electrically conductive structure. It is particularly preferred that the electrically conductive structure is open in design, i.e. has open ends or in other words is characterized by a beginning and an end and/or is not connected to form a ring or similar self-contained shape or geometry.

In a preferred embodiment, the electrically conductive structure comprises at least one line-shaped main element and at least one line-shaped sub-element, wherein the main element and the sub-element are galvanically connected to each other and preferably enclose an angle of 10° to 80°, more preferably 20° to 60°.

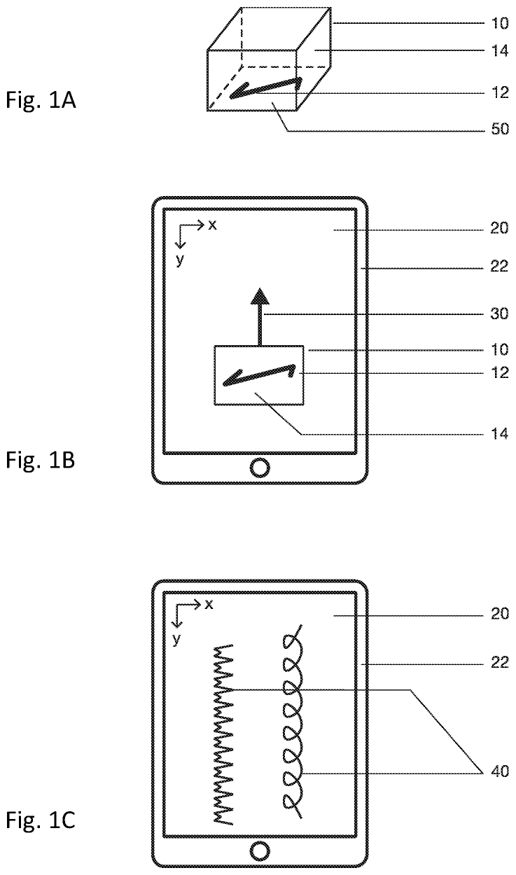

For example, the main element can have a length of 20 mm to 60 mm, while the sub-element has a length of 5 mm to 20 mm. Preferably, both the main element and the sub-element are rectilinear structures. It may also be preferred to position two sub-elements at different ends of the main element. As the examples (cf. FIG. 1-8) show, electrical structures with such angled sub-elements are particularly suitable for generating periodic signals via a surface sensor when the device is moved in accordance with the invention.

In a preferred embodiment of the invention, the contact surface has a substantially rectangular shape with the main element having an angle of from 5° to 45°, preferably from 10° to 35° to one of the two edges of the contact surface.

Such a rectangular shape is present, for example, in cuboid packaging or a flat rectangular card. Typically, a user will place the device on a surface sensor such that the edge of the rectangle is aligned with an edge of a, typically, rectangular surface sensor, preferably moving along the horizontal or vertical of the surface sensor. The orientation of the angle of the main element with respect to the edge of the contact surface thus preferably dictates the orientation of the main element when the device is used on a surface sensor.

The aforementioned angles can be used to bridge two electrode intersections in a particularly effective manner, whereby, in addition, depending on the positioning of two sub-elements at different heights, an oscillation as described is effected and thus a periodic signal is generated.

It is preferred in the sense of the invention that the periodic signal can be assigned a period length as a characterizing quantity of the periodic signal, the period length preferably corresponding to the reciprocal value of the spatial frequency with which the periodic signal fluctuates. It is particularly preferred in the sense of the invention that the period length is determined by the arrangement and/or design of the electrode grid of the surface sensor. It was particularly surprising that the spatial frequency of the periodic signal correlates with the grid constant of the electrode grid of the surface sensor. In other words, it is preferred in the sense of the invention that the spatial or local periodicity of the periodic signal is determined by the arrangement and/or the design of the electrode grid of the surface sensor. It is quite particularly preferred in the sense of the invention that the period length of the periodic signal is determined by the geometry of the electrode grid in the capacitive surface sensor, the arrangement and/or design of the electrode grid of the surface sensor preferably also being referred to as the “geometry of the electrode grid”. Surprisingly, the period length of the signal reflects the arrangement of the electrodes in the electrode grid of the surface sensor.

It is preferred in the sense of the invention that the period length of the signal is between 2 mm and 9 mm. The period length of the signal correlates with the geometry of the electrode grid, in particular with the grid constant. The grid constant in capacitive surface sensors is preferably in the range between 2 and 9 mm. Preferably, the period length is at least 3 mm and at most 7 mm, since said range surprisingly correlates with the grid constant of capacitive surface sensors especially of cell phones, smartphones, tablets or comparable devices. It is particularly preferred that the period length of the signal is between 4 and 5 mm. A corresponding grid constant in capacitive surface sensors is particularly suitable for reliably detecting finger inputs on capacitive surface sensors. Many devices that incorporate a capacitive surface sensor have a corresponding grid constant. It was particularly surprising to find that the periodic signals have a period length between 4 and 5 mm. Surprisingly, the inventors succeeded in drawing conclusions about the geometry of the electrode grid by evaluating the period length of the periodic signals.

It is preferred in the sense of the invention that the periodic signal can further be assigned a period duration as a characterizing quantity of the periodic signal, the period duration preferably corresponding to the reciprocal value of the frequency with which the periodic signal fluctuates. It is particularly preferred in the sense of the invention that the period duration, i.e. the periodicity in time of the periodic signal is determined by the geometry of the electrode grid of the surface sensor in interaction with the speed of the relative movement with which the device is moved over the surface sensor. In this context, the x-coordinate and/or the y-coordinate of the periodic signal may be represented respectively as a function of time, that is, as a function of the x-coordinate x(t) and as a function of the y-coordinate of the periodic signal y(t). It is particularly preferred in the sense of the invention that the periodic signal has a period duration of at least 25 ms and particularly preferred of at least 50 ms. It is further particularly preferred that the periodic signal has a period duration of at most 1 s and particularly preferred of at most 500 ms.

It is particularly preferred in the sense of the invention that the device or the three-dimensional object is formed by a package or a folding box. It is further preferred that the three-dimensional object is abbreviatively referred to as an “object”. Preferably, the object is a cuboidal structure having a height, a width and a length.

In a preferred embodiment, the object has six side surfaces. The side surface of the object that faces the surface sensor is preferably referred to as the bottom side (or underside) of the object. Alternatively, the surface of the object facing the surface sensor is also referred to as the contact surface and need not necessarily be the bottom side of the object with respect to the intended use of the object. In the following, bottom side, underside and contact surface are used synonymously and refer to the function of said surface to be suitable for interacting with the capacitive surface sensor.

The side surface of the object opposite the bottom surface is preferably referred to as the top surface of the object. The remaining four surfaces of the object are preferably referred to as the side surfaces. The formulation that the electrically conductive structure is present at least arranged on the bottom side of the three-dimensional object preferably means in the sense of the invention that the electrically conductive structure is present in any case on the bottom side of the object and, in a preferred embodiment of the invention, only at said bottom side. In other words, the entire electrically conductive structure is present on the bottom side or contact surface of the device in this preferred embodiment of the invention. In particular, it is preferred in the sense of the invention that the entire electrically conductive structure is suitable for interacting with the electrode grid of the capacitive surface sensor. This is preferably achieved by the electrically conductive structure being present substantially entirely on the bottom side of the object. It may also be preferred in a particular embodiment that the electrically conductive structure is present arranged on the inner side of the bottom side of the three-dimensional object, for example a folding box. In a further preferred embodiment, the electrically conductive structure may be optically concealed by a layer of paint and/or a layer of lacquer and/or by a laminate material so that the electrically conductive structure is not visible to the user or operator. The interaction between the electrically conductive structure and the capacitive surface sensor is preferably a capacitive interaction, i.e. there is no direct galvanic contact between the electrically conductive structure and the surface sensor.

The shape of the object is not limited to cuboid or cube geometries. Other shapes, for example cylinders, tetrahedrons or other geometries or bodies are also possible embodiments.

It may also be preferred in other embodiments of the invention that individual elements or regions of the electrically conductive structure are further, i.e. additionally further, present on one or more side surfaces of the object. In this embodiment of the invention, it is preferred that at least a portion of the electrically conductive structure is suitable for interacting with the electrode grid of the capacitive surface sensor. For example, in this embodiment of the invention, a contact surface may be positioned on one of the side surfaces of the device or the three-dimensional object. In the sense of the invention, a touch surface is a sub-element of the electrically conductive structure, which is formed in such a way that it is conductively connected to the electrically conductive structure, so that by touching the touch surface of the electrically conductive structure, a potential change of the system of electrically conductive structure and surface sensor is caused, wherein said potential change can preferably be detected by the surface sensor. The term contact surface is used synonymously for contact area.

In a further preferred embodiment, the width and length of the object is significantly greater than the height of the object. Such an object may be described, for example, as a card-shaped object and is characterized by being a substantially flat object. It may be further preferred that the flat object is flexible and/or bendable. Preferably, the side surface of the object facing the surface sensor is referred to as the bottom surface of the object, while the side surface of the object opposite the bottom surface is referred to as the top surface of the object. The remaining four side surfaces are preferably referred to as side surfaces. The formulation that the electrically conductive structure is present at least arranged on the bottom side of the three-dimensional object preferably means in the sense of the invention that the electrically conductive structure is present in any case on the bottom side of the object and, in a preferred embodiment of the invention, only at said bottom side. In other words, the entire electrically conductive structure is present on the bottom side of the device in this preferred embodiment of the invention. In particular, it is preferred in the sense of the invention that the entire electrically conductive structure is suitable for interacting with the electrode grid of the capacitive surface sensor. This is preferably achieved by the electrically conductive structure being present substantially entirely on the bottom side of the object.

Surface sensors in particular comprise at least one active circuit, preferably referred to as a touch controller, which may be connected to a structure of electrodes. The electrode structure is preferably also referred to as an “electrode grid” for the purposes of the invention. Surface sensors are known in the prior art whose electrodes comprise groups of electrodes which differ from one another, for example, in their function. These may be, for example, transmitting and receiving electrodes which, in a particularly preferred arrangement, may be arranged in column and row form, that is, in particular, form nodes or intersections at which at least one transmitting and one receiving electrode each intersect or overlap. Preferably, the intersecting transmitting and receiving electrodes are aligned with one another in the region of the nodes in such a way that they form an angle of essentially 90° with one another.

Terms such as substantially, approximately, about, etc. preferably describe a tolerance range of less than ±20%, preferably less than ±10%, even more preferably less than ±5% and in particular less than ±1%. Indications of substantially, approximately, about, etc. always also disclose and include the exact value mentioned.

It is particularly preferred in the sense of the invention that an electrostatic field is formed between the transmitting and receiving electrodes of the surface sensor, which is sensitive to changes. Said changes can be caused, for example, by touching the surface of the surface sensor with a finger or a conductive object, by touching a touching surface or grasping surface of an electrically conductive structure which is at least partially located on the surface sensor, or in particular by bringing the surface sensor into contact with an electrically conductive structure which is arranged, for example, on the bottom side of a device. In particular, such changes lead to changes of potential within the electrostatic field, which is preferably caused by the fact that, for example, the electric field between the transmitting and receiving electrodes is locally reduced by contacting a contact surface of an electrically conductive structure. Such a change in electrical potential is detected and further processed by the electronics of the touch controller.

It is preferred in the sense of the invention that the touch controller preferably controls the electrodes in such a way that a signal is transmitted between one or more transmitting electrodes and one or more receiving electrodes in each case, which signal can preferably be an electrical signal, for example a voltage, a current or a potential (difference). These electrical signals in a capacitive surface sensor are preferably evaluated by the touch controller and processed for the operating system of the device. The information transmitted by the touch controller to the operating system describes so-called individual “touches” or “touch events”, each of which can be thought of as individual detected touches or can be described as individual inputs. These touches are preferably characterized by the parameters “x-coordinate of touch”, “y-coordinate of touch”, “timestamp of touch” and “type of touch”. The “x-coordinate” and “y-coordinate” parameters describe the position of the input on the touchscreen. Each pair of coordinates is preferably assigned a timestamp that describes when the input occurred at the corresponding position. The “touch event type” parameter describes the detected state of the input on the touchscreen. The skilled person is familiar with the types Touch Start, Touch Move, Touch End and Touch Cancel, among others. With the help of the parameters Touch Start, at least one Touch Move and Touch End as well as the associated coordinates and time stamps, a touch input on the capacitive surface sensor can be described. It is preferred and known in the prior art as multi-touch technology that several touch inputs can be evaluated simultaneously.

In the sense of the invention, the periodic signal preferably comprises a set of such touches and/or touch inputs, wherein properties of the signal preferably depend on the concrete shape of the electrically conductive structure, as well as on the structural arrangement of the transmitting and receiving electrodes of the surface sensor. In other words, it is preferred in the sense of the invention that the periodic signal is formed by a set of touches and/or touch inputs that have recurring properties and/or periodicity in spatial and/or temporal terms. In particular, it is preferred in the sense of the invention that the course of the periodic signal is determined by the electrically conductive structure. Projected capacitance touch technology (PCT) is an exemplary technology which allows multi-touch operation.

Preferably, the set of touch events or touches is processed and evaluated using a software program (‘app’). The evaluation can comprise several steps. Preferably, first the device parameters of the apparatus which includes the surface sensor, e.g. the resolution of the touch screen, are determined. Depending on the apparatus, the signal comprising a set of touch events is preferably pre-filtered in the next step and specific characteristics of the signal are amplified or adjusted. Subsequently, the signal is checked for plausibility by calculating parameters such as temporal course of the signal, velocity and data density and checking them for possible manipulation and comparing them with known threshold values. It is preferred that subsequently various characteristic values and parameters of the signal are determined or calculated, including the characteristic values start of the signal, end of the signal, local maxima and minima, local velocities of the signal, displacement, amplitudes, period length of periodic signals and possibly other characteristics, in order to convert the signal into a comparable data set. In particular, it is preferred to subsequently compare this data set with other data sets and to assign it to a known data set located, for example, in a database, and thus to decode the signal. In a further preferred embodiment, the matching of the data set takes place using a machine learning model (artificial neural networks) previously created from recordings. It was surprising that the use of a machine learning model to decode the signal is particularly suitable for complex signals with many different parameters.

The decoding of the signal preferably comprises an assignment of the detected periodic signal to a known electrically conductive structure or an identification code represented thereby. Advantageously, it has been shown that the periodic signal generated by the relative movement of the electrical structure on the surface sensor is particularly tamper-proof, i.e. safe from manipulation. An imitation of the complex periodic signal with another electrically conductive structure (i.e. without presenting the identification code) is almost impossible.

The device or system is therefore particularly suitable for authentication methods, for example to grant a user access to information or an action, when the device is placed on a mobile terminal and moved via the surface sensor in accordance with the invention.

For the purposes of the invention, the term “capacitive surface sensor” preferably refers to such touch sensor-applying devices that are capable of sensing external influences or impacts, for example contacts, on the surface of the touch sensor and evaluating them by means of attached logic. Such surface sensors are used, for example, to allow easier operation of machines. In addition to touch sensors, which are primarily used for input, there are touchscreens which are in addition display devices and/or output devices. In order to make an input on a capacitive screen, which is preferably also referred to as a touch screen, touchscreen or surface sensor, special input pens or similar devices can be used in addition to fingers. For the purposes of the invention, fingers as well as special input pens are preferably subsumed under the term input means. These are preferably capable of changing an electrostatic field between row and column electrodes within the surface sensor. The capacitive, preferably touch-sensitive screen is preferably adapted to detect the position of the finger or input pen.

Typically, surface sensors are provided in an electronic device and may include, but are not limited to, smartphones, cell phones, displays, tablet PCs, tablet notebooks, touchpad devices, graphics tablets, televisions, PDAs, MP3 players, trackpads, and/ or capacitive input devices.

The term “apparatus including a surface sensor” or “apparatus including a surface sensor” preferably refers to electronic apparatus or devices, such as those mentioned above, which are capable of further evaluating the information provided by the capacitive surface sensor. In preferred embodiments, these are mobile device (or mobile terminals).

Touchscreens are preferably also referred to as touch screens, surface sensors or sensor screens. A surface sensor need not necessarily be used in conjunction with a display or a touchscreen. It may also be preferred in the sense of the invention that the surface sensor is integrated visibly or non-visibly in devices, objects and/or appliances.

It was completely surprising in the context of the present invention that the proposed device and the proposed system can dispense with the use of such an input stylus or finger, since the change in coupling between the transmitting and receiving electrodes in the context of the present invention is taken over or effected by the electrically conductive structure of the device. In particular, it was completely surprising that the electrically conductive structure in the context of the present invention does not have to be activated by a user by touching a sub-region of the structure, but that the surface sensor recognizes the device or its electrically conductive structure also without a touch and/or activation. In this respect, the invention represents a significant departure from the known prior art, since those skilled in the art had previously assumed that an activation of an electrically conductive structure, for example by the touch of a user, was required in order to be recognized by the capacitive surface sensor. The present invention discloses a device and system in which, surprisingly, an input means for generating a periodic signal can be dispensed with.

The fact that the surface sensor is enabled to detect the electrically conductive structure of the device without the structure being activated by a user touch is advantageously based on a coupling between the capacitive surface sensor and the electrically conductive structure, which exists in particular when the electrically conductive structure interacts with at least two rows and at least two columns, or at least two transmitting electrodes and at least two receiving electrodes, of the electrode grid of the capacitive surface sensor. In other words, it is preferred that the electrically conductive structure overlaps with at least two electrode intersections. A charge carrier exchange may in turn occur between the surface sensor, or its electrodes, and the electrically conductive structure. It may also be preferred in the sense of the invention that the electrically conductive structure on the three-dimensional object causes the electrodes of the electrode grid in the surface sensor to interact with each other indirectly via the electrically conductive structure. It is particularly preferred in the sense of the invention that the electrically conductive structure is arranged to bridge a distance between the at least two transmitting and receiving electrodes. Preferably, this results in a capacitive connection between at least two different electrode intersections (crossings), which is in particular established and maintained by the electrically conductive structure. It is preferred in the sense of the invention that the electrically conductive structure interconnects the columns and rows of the electrode grid of the surface sensor, so that an interaction between the at least four electrodes concerned (two transmitting electrodes and two receiving electrodes) is produced here. It is particularly preferred in the sense of the invention that the electrically conductive structure is arranged to effect bridging and/or connection of electrode intersections within the electrode grid of the surface sensor. Preferably, the connection and/or bridging of the electrode intersections is based on a capacitive interaction, also referred to as capacitive coupling. In other words, the connection and/or bridging is not based on a galvanic connection, but on a capacitive connection. Advantageously, this may lead to a self-induced signal generation, in particular to a generation of the desired periodic signal upon movement of the device via the capacitive surface sensor.

In a preferred embodiment, the electrically conductive structure comprises at least one main element. In a further preferred embodiment, the electrically conductive structure comprises at least one sub-element in addition to the main element. The main element and one or more sub-elements are galvanically connected to each other and form the electrically conductive structure in their entirety. The electrically conductive structure can be characterized by the design of the main element as well as the design of the sub-elements. For purposes of the invention, the term design includes, but is not limited to, the shape, size, geometry, length, width, orientation, position, and angle of the element of the electrically conductive structure. For example, main and/or sub-elements may be linear, circular, or arced shape without being limited thereto. In one embodiment, the transition between the sub-element and the main element may be smooth or take the shape of an arc. It may also be preferred to galvanically connect a sub-element to another sub-element instead of the sub-element. The number, arrangement and orientation of the sub-elements is not limited to the variants described.

An electrically conductive structure is defined as the entirety of the main and sub-elements galvanically connected to each other. It may also be preferred that there are two or more electrically conductive structures on a contact surface of the object, characterized by the fact that they are not galvanically connected to each other.

The electrically conductive structure interacts with the electrode grid of the capacitive surface sensor. In particular, different electrode intersections interact with the electrically conductive structure or one or more focal points of the electrically conductive structure at each point in time of the interaction. In particular, an electrode intersection interacts with the electrically conductive structure if the electrically conductive structure overlaps the selected electrode intersections at a time x. In particular, the surface centroids of the electrically conductive structure interact with the capacitive surface sensor or the electrode grid. At points where the centroids of the electrically conductive structure overlap with the electrode intersections, the capacitive surface sensor is activated or, in other words, a touch event is generated.

If the device comprising the electrically conductive structure is moved over the electrode grid of the capacitive surface sensor, the electrically conductive structure or the focal points of the area gradually interact with other electrode intersections. This results in a superposition of two different geometries: on the one hand the geometry of the electrode grid and on the other hand the geometry of the electrically conductive structure. If these two geometries are shifted against each other, the two geometries overlap. This superposition is repeated cyclically or periodically. This leads to periodically arranged touch events on the capacitive surface sensor, which in turn form the periodic signal in their entirety.

Similar effects are known to the skilled person from optics under the term interference. It was completely surprising that an electrically conductive structure would interact in this way with the capacitive surface sensor.

It is preferred that the electrically conductive structure interacts with at least two rows and at least two columns at any time during the movement. In particular, it is preferred that the respective two columns and/or respective two rows are not adjacent. In other words, it is preferred that the electrically conductive structure interconnects or bridges two spaced rows and/or two spaced columns.

It is particularly preferred in the sense of the invention that this connection between different electrode intersections and the transmitting and receiving electrodes of the electrode grid, respectively, makes the activation of the electrically conductive structure by the touch of a user obsolete, so that, in the context of the present invention, the use of an input means, such as the finger of a user, can be dispensed with. Preferably, the beneficial effects and technical effects of the invention are based on the interaction between the electrically conductive structure and the surface sensor, more preferably between the electrically conductive structure and the electrode grid of the surface sensor, and most preferably between the electrically conductive structure and the columns and rows of the transmitting and receiving electrodes of the electrode grid of the surface sensor. In terms of the invention, said interaction preferably results in a change in the electrostatic field between the electrodes in a surface sensor and/or a measurable change in capacitance. In particular, the change in electrostatic field can be caused by a relative movement between the surface sensor and the three-dimensional object. It is quite particularly preferred in the sense of the invention that the periodic signal is generated by a relative movement between the electrically conductive structure and the surface sensor. In the sense of the invention, said relative movement can preferably also be referred to as a dynamic effective contact. It is preferred in the sense of the invention that the duration of the relative movement determines the duration of the periodic signal. In this context, duration means in particular the total duration of the signal. It is particularly preferred in the sense of the invention that the periodic signal has a duration of at least 250 ms, preferably of at least 500 ms and particularly preferably of at least 750 ms.

The present invention also departs from the prior art in that a touch structure on the device is no longer required to generate a signal on the surface sensor. A touch structure as known from the prior art presupposed a certain spatial structure of predefined elements of an electrically conductive structure, namely in particular a touch point, a coupling surface and conductive means for connection. The presence of these predefined elements and their functionalities is not required in the context of the present invention, nor is the need for the electrically conductive structure to replicate or mimic the characteristics of fingertips. In particular, the proposed device does not require a specific coupling surface to be touched by a user in order to activate the electrically conductive structure for the surface sensor. Typically, surface sensors are provided in an electrical apparatus or device and may include, but are not limited to, smartphones, cell phones, displays, tablet PCs, tablet notebooks, touchpad devices, graphics tablets, televisions, PDAs, MP3 players, trackpads, and/or capacitive input devices. Touchscreens are preferably also referred to as touch screens, surface sensors or sensor screens. A surface sensor need not necessarily be used in connection with a display or a touchscreen. It may be equally preferred in the sense of the invention that the surface sensor is visibly or non-visibly integrated in devices, objects and/or appliances. For example, it may be preferred in the sense of the invention to use multi-touch capable surface sensors. Such surface sensors are preferably adapted to recognize multiple touches simultaneously, whereby, for example, elements displayed on a touchscreen can be rotated or scaled with the aid of special gestures.

It is preferred in the sense of the invention that the electrically conductive structure is arranged to define a course of the periodic signal with respect to a curve shape, an amplitude and/or an edge shape (or flank, slope). In other words, it is preferred in the sense of the invention that the design of the electrically conductive structure determines the course of the periodic signal, in particular the curve shape, the amplitudes and/or the edge shapes.

In the sense of the invention, the term “curve progression” preferably describes the graphical representation or reproduction of the x(y) function in the coordinate system, which can be mentally placed over the screen of the surface sensor. In particular, the term describes the course of the x(y) function in the virtual coordinate system. The term “amplitude” preferably describes the maximum deviation from a fixed center position around which the periodic signal can fluctuate. It is preferred in the sense of the invention that the amplitude of the signal is at least 1 mm, so that the amplitude of the periodic signal can be evaluated when evaluating the set of touch signals or touch events. The amplitude is preferably at least 2 mm and particularly preferably at least 3 mm. It was particularly surprising that possible deviations or tolerances, which can be caused by the relative movement between the device and the capacitive surface sensor, can be neglected in the analysis of the signal and that the signal-to-noise ratio is as large as possible, i.e. that the amplitude of the periodic signal is as large as possible compared to possible deviations. Furthermore, it is preferred in the sense of the invention that the amplitude of the periodic signal is a maximum of 60 mm, since this corresponds to the approximate maximum width of current capacitive surface sensors in cell phones or smartphones. Particularly preferably, the amplitude of the periodic signal is a maximum of 40 mm, since a corresponding periodic signal can be evaluated particularly well. Surprisingly, a corresponding signal can be evaluated particularly well in combination with another periodic signal.

The term “shape of an edge” (or course of an edge/flank) preferably describes the course of the signal more precisely and includes, but is not limited to, the quantities rise, fall and steepness of an edge (flank, slope).

It is preferred in the sense of the invention that the electrically conductive structure is arranged to define a periodic non-harmonic signal. Non-harmonic signals can preferably be represented by an overlap of multiple harmonic signals. In other words, the appearance of the signal can also be described as a wriggling, wobbling or trembling.

In a preferred embodiment, it is preferred that the position-dependent signal shows a loop-shaped progression. In other words, the electrically conductive structure is configured so that the coordinate of the signal in whose direction the device is moved via the capacitive surface sensor periodically increases and decreases, i.e. the signal runs partially backwards relative to the direction of movement of the electrically conductive structure. The course on the capacitive surface sensor can be represented as a loop-shaped or I-shaped course (small L in handwriting notation) of the signal.

It is preferred in the sense of the invention that the electrically conductive structure is present both on the contact surface, i.e. on the surface of the device which is intended for effective contact with the surface sensor, and on at least one further surface of the device. In other words, it is preferred in the sense of the invention that the electrically conductive structure is present both on the bottom surface serving as contact surface and on at least one side surface of the device. This feature is substantially equivalent to saying that at least a region of the electrically conductive structure is adapted to interact with the electrode grid of the capacitive surface sensor. Preferably, the region of the electrically conductive structure that interacts with the surface sensor is the region of the electrically conductive structure disposed on the contact surface of the three-dimensional object. At least a region of the electrically conductive structure is present on the contact surface of the three-dimensional object, while in preferred embodiments of the invention it may also be preferred that, in addition to the regions of the electrically conductive structure present on the contact surface of the device, further regions of the electrically conductive structure are present on the adjacent surfaces of the device. Thus, in terms of the invention, it may be preferred that substantially all of the electrically conductive structure is present on the contact surface of the three-dimensional object or that only a region of the electrically conductive structure is present.

When substantially all of the electrically conductive structure is present on the contact surface of the device, the corresponding device is particularly easy to manufacture because only one side of the three-dimensional object needs to be printed or provided with electrically conductive material. This feature is essentially equivalent to saying that the entire electrically conductive structure is suitable for interacting with the electrode grid of the capacitive surface sensor. Furthermore, this embodiment of the invention avoids difficulties that may arise, for example, when an element of the electrically conductive structure is present on two sides of the object, in the sense that this element must then extend over an edge of the object. A disadvantage in the prior art is the need for the electrically conductive structure to passed over one or more edges of a three-dimensional object. Such a design may lead to problems because it is the edges of the object that are subjected to greater mechanical stresses than, for example, the inner surfaces of the side faces or the bottom surface of the object. For example, in the manufacturing process of a folding box, especially in the processes of creasing, punching, erecting, gluing and assembling, strong mechanical loads act particularly in the area of the edges of the folding box. This can lead to a reduction in electrical conductivity or even to breakage of the electrically conductive structure. Thus, the arrangement of the electrically conductive structure exclusively on one side of the object represents a decisive advantage over the solutions known from the prior art.

It is preferred in the sense of the invention that the electrically conductive structure is arranged to interact with at least two rows and at least two columns of an electrode grid of the capacitive surface sensor. It is preferred in the sense of the invention that the rows of the electrode grid of the surface sensor are substantially formed by transmitting electrodes and the columns of the electrode grid of the surface sensor are substantially formed by receiving electrodes, or vice versa. It is particularly preferred in the sense of the invention that the columns of the electrode grid of the surface sensor comprise either only transmitting electrodes or only receiving electrodes in a purely sorting manner. It is further preferred that the rows of the electrode grid of the surface sensor also comprise, in a pure sorting manner, either only transmitting electrodes or only receiving electrodes. In other words, it is thus preferred in the sense of the invention that the electrically conductive structure of the three-dimensional object is arranged to interact with at least two receiving electrodes and at least two transmitting electrodes of the electrode grid of the capacitive surface sensor. It may be preferred that the electrodes are each two adjacent transmitting and receiving electrodes. In a further embodiment, it may in particular also be preferred that the transmitting and/or receiving electrodes are spaced apart, i.e. that further electrodes are located between the electrodes which interact. Preferably, the transmitting electrodes, which are preferably arranged side by side, are arranged substantially parallel to each other. Likewise, it is preferred that the receiving electrodes preferably arranged side by side are present substantially parallel to each other. It is preferred in the sense of the invention that the receiving electrodes of the electrode grid of the surface sensor are arranged substantially perpendicular to the transmitting electrodes of the electrode grid, wherein the term “substantially” is not unclear to the average person skilled in the art, because the average person skilled in the art knows how the term is to be understood in practice. In particular, the skilled person knows that, for example, slight deviations from exact parallelism or orthogonality may occur due to manufacturing. However, such deviations are also intended to be encompassed by the formulations “essentially parallel” and “essentially perpendicular” in the sense of the invention.

Preferably, a pattern similar to a check pattern results between two preferably adjacent transmitting and receiving electrodes. It is particularly preferred in the sense of the invention that the electrically conductive structure interacts with at least two rows and at least two columns, respectively at least two transmitting electrodes and at least two receiving electrodes, of the electrode grid of the capacitive surface sensor. Surprisingly, it has been found that the course of the periodic signal is determined by the interaction of sub-regions of the electrically conductive structure with the electrode grid of the capacitive surface sensor. The determination of the periodic signal may be achieved in particular by the interaction between the specific configuration of the electrically conductive structure with the at least two transmitting and receiving electrodes.

In another aspect, the invention relates to a system for generating a periodic signal on a capacitive surface sensor, the system comprising a device, and a capacitive surface sensor. The system is characterized in that the periodic signal on the capacitive surface sensor is generated by a relative movement between the electrically conductive structure and the surface sensor. In other words, it is preferred in the sense of the invention that the electrically conductive structure on the device is arranged to determine the course of the periodic signal in interaction with the electrode grid of the capacitive surface sensor. Particularly preferably, the electrically conductive structure is arranged in such a way that, when the device is moved relative to the surface sensor along the direction of a row or a column of the electrode grid, a periodic signal is generated which oscillates orthogonally to the movement of the device.

It was completely surprising that a system for generating a periodic signal on a capacitive surface sensor can be provided in such a way that the provision or use of a special input means can be dispensed with. In particular, in a preferred embodiment, the invention surprisingly does not require human input. The proposed system comprises a device, which is preferably a three-dimensional object, and a capacitive surface sensor, which in the sense of the invention is preferably abbreviated to “surface sensor.” Preferably, in particular, the course of the periodic signal is determined by the configuration of the electrically conductive structure on the device, while the period length of the periodic signal is determined by the configuration of the surface sensor, in particular its electrode grid of transmitting and receiving electrodes. In other words, it is particularly preferred in the sense of the invention that the period length of the periodic signal is determined by the geometry of the electrode grid in the capacitive surface sensor. Preferably, the arrangement and/or design of the electrode grid of the surface sensor may also be referred to as the “geometry of the electrode grid”. It is preferred in the sense of the invention that the duration of the interaction between the electrically conductive structure and the surface sensor determines the time duration of the periodic signal. In this context, time duration of the periodic signal means in particular the total duration of the periodic signal. In the sense of the invention, it is particularly preferred that the periodic signal has a duration of at least 250 ms, since a minimum duration of the periodic signal is required so that the characteristic values of the signal can be evaluated accordingly. The duration of the periodic signal is particularly preferably at least 500 ms, since this means that a larger number of touch data or touch events are available for evaluation and average values can be formed over the characteristic values, for example the amplitude of the signal.

For a particularly reliable and accurate evaluation of the signal, the periodic signal has a particularly preferred minimum duration of at least 750 ms.

Thus, the proposed system provides the possibility to generate a periodic signal on a surface sensor by moving a device, in particular a three-dimensional object, over the surface sensor. In particular, the deliberate and intentional generation of periodic signals by a specific configuration or design of an electrically conductive structure on a device or by a specific configuration or geometry of the electrode grid of a surface sensor has not been described in the prior art so far. It was completely surprising that the properties of the periodic signal to be generated can be deliberately influenced, varied and/or changed by the specific design and/or influencing and/or changing of the structural configuration of the electrically conductive structure and/or the electrode grid. The properties of the periodic signal that can be adjusted in this way are preferably the spatial and/or temporal properties of the periodic signal, for example its amplitude or period length or period duration. It was completely surprising that the spatial and/or temporal properties of a periodic signal can be influenced by providing a system comprising a device with an electrically conductive structure and a surface sensor. It was completely surprising that the invention can provide a particularly intuitive and user-friendly interactive system, with the help of which an object or its user can be verified and/or identified particularly reliably and unambiguously by a capacitive surface sensor. The proposed device and the proposed system are particularly secure against manipulation and the corresponding electrically conductive structure cannot, in particular, be imitated by fingertips or manipulated by a user.

In the context of the invention, the term “identification” preferably means that a device or object is recognized by the surface sensor and can be assigned, for example, to a data record stored in the electrical device containing the surface sensor. In this context, the data record may, for example, also not be stored directly in the electrical device, but may be accessible to it, for example by being retrievable on a server, on the internet and/or in a cloud. The object is detected by the surface sensor in particular by detecting the electrically conductive structure arranged on the object. This electrically conductive structure is determined in particular by the design of the entire electrically conductive structure and/or its sub-regions.

The term “verification” in the sense of the invention preferably means that the authenticity or the genuineness of an object can be determined or proven. In the prior art, holograms, for example, have been known for a long time. However, it is often only possible for those skilled in the art to verify or prove the authenticity of a hologram. It was completely surprising that with the present invention a doubtless verification of the feature in the form of the electrically conductive structure can be carried out with the help of a device, which contains a surface sensor, for example a smartphone. Areas of use for such an application are in the field of product protection and document protection.

In a further preferred embodiment, it is preferred that the electrically conductive structure on an object serves as an access key to digital content. In other words, it is preferred that the electrically conductive feature serves as a key for unlocking digital content, for example, warranty certificates, vouchers, coupons, digital media, and the like.

It is provided in the sense of the invention that the periodic signal on the capacitive surface sensor is generated by a relative movement between the electrically conductive structure and the surface sensor. The device or object is preferably arranged for generating such a periodic signal on a capacitive surface sensor, wherein the periodic signal is generated in particular by a relative movement between the electrically conductive structure and the surface sensor. In other words, this preferably means that the device and the surface sensor are displaced relative to each other so that a movement of the two objects relative to each other is caused. This can be achieved, for example, by moving the object on or over the screen of a surface sensor. In this case, the device or its contact surface preferably rests on the screen of the surface sensor. It is particularly preferred in the sense of the invention that the device is pulled over the surface sensor in order to obtain a relative movement with which the periodic signal is generated on the surface sensor. Preferably, said pulling or pushing motion is referred to as relative motion.

It is preferred in the sense of the invention that the duration of the relative movement determines the duration of the periodic signal. In this context, duration means in particular the total duration of the signal. In particular, it is preferred in the sense of the invention that the periodic signal has a duration of at least 250 ms, preferably of at least 500 ms and particularly preferably of at least 750 ms.

The system according to the invention is preferably adapted to detect and evaluate the described generation of a periodic signal in order to identify or verify the applied electrical structure.

In a preferred embodiment, the system has a data processing device which is adapted to evaluate the periodic signal, the data processing device preferably having software (‘app’) installed on it which comprises commands to determine dynamic characteristics of the periodic signal and to compare them with reference data.

In a preferred embodiment, the device comprising the surface sensor has a data processing device which is adapted to evaluate the periodic signal, the data processing device preferably having installed on it software (‘app’) which comprises commands to determine dynamic characteristics (dynamic characteristic values, dynamic parameters) of the periodic signal and to compare them with reference data.

In a further preferred embodiment, the software is provided at least in part in the form of a cloud service or internet service, wherein the device transmits the touch data or touch events over the internet to an application in the cloud. Also in this case, software (‘app’) is present on a data processing device comprising instructions to determine dynamic characteristics of the periodic signal and compare them with reference data. However, the software installed on the data processing device of the instrument does not perform all computationally intensive steps independently on the instrument. Instead, the data about the periodic signal or the amount of touch events is transmitted to a software application in a cloud (with an external data processing device) for determining dynamic characteristics and comparing them with reference data.

The software as a cloud service, which preferably comprises commands to determine dynamic characteristics of the periodic signal and compare them with reference data, processes the periodic signal in the form of a set of touch events and sends the result back to the device comprising the surface sensor or to the software installed on it. The software on the device can preferably further process the results and, for example, control their display.

When preferred features of the software are described below, a person skilled in the art recognizes that these preferably apply equally to software that performs the steps entirely on the device and to software that has outsourced some (preferably computationally intensive) steps, such as the determination of dynamic characteristics and their comparison with reference data, to an external data processing device of a cloud service. A person skilled in the art recognizes that the provided evaluation of the periodic signal is to be understood as a unified concept, regardless of which steps of the algorithm are performed on the device itself or by an external data processing device on a cloud. In preferred embodiments, for example, a determination of the dynamic characteristics of the periodic signal can also be performed by the software on the device and only the comparison of the dynamic characteristics with reference data can be performed outsourced by a cloud service.

The apparatus containing the surface sensor is preferably an electronic apparatus or device which is able to further evaluate the information provided by the capacitive surface sensor. The capacitive surface sensor or the apparatus preferably has an active circuit, also called touch controller, which allows an evaluation of touch signals on the surface sensor as described above. By means of the touch controller and an operating system provided on the electronic device, the periodic signal is preferably processed as a set of touch events.

A touch event preferably refers to a software event provided by the operating system of the device with the capacitive surface sensor when an electronic parameter detected by the touch controller changes.

An operating system preferably refers to the software that communicates with the hardware of the device, in particular the capacitive surface sensor or touch controller, and enables other programs, such as software (‘app’) to run on the device. Examples of operating systems for devices with capacitive surface sensor are Apple's iOS for iPhone, iPad and iPod Touch or Android for running various smartphones, tablet computers or media players. Operating systems control and monitor the hardware of the device, especially the capacitive surface sensor or a touch controller. Preferably, operating systems for the claimed system provide a set of touch events that reflect the periodic signal.

When the device is guided over the surface sensor, a touch start, a touch move and touch end can be detected at different positions, for example, and the time sequence can be traced using the x or y coordinates and the time stamps of the touches.

Preferably, the relative motion of the device causes alternate generation of touch events that reflect the periodicity of the electrode grid as described. Preferably, the periodic signal is processed by the operating system or touch controller of the electronic device, such as a smartphone.

The software (‘app’) installed on the data processing device preferably evaluates the periodic signal based on the detected set of touch events.

The data processing device is preferably a unit which is suitable and configured for receiving, sending, storing and/or processing data, preferably touch events. The data processing unit preferably comprises an integrated circuit, a processor, a processor chip, a microprocessor and/or microcontroller for processing data, as well as a data memory, for example a hard disk, a random access memory (RAM), a read-only memory (ROM) or even a flash memory for storing the data. In commercially available electronic devices with surface sensors, such as the mobile terminals or smart devices, corresponding data processing devices are present.

The software (‘app’) may be written in any programming language or model-based development environment, such as C/C++, C#, Objective-C, Java, Basic/VisualBasic, or Kotlin. The computer code may include subroutines written in a proprietary computer language specific to reading or controlling or other hardware component of the device.

In particular, the software preferably determines dynamic characteristics (i.e. dynamic characteristic values or parameters) of the periodic signal (preferably in the form of a set of touch events) in order to compare these reference data. Dynamic characteristics of the periodic signal are, for example, the period length, the curve shape, the amplitude and/or the edge shape.

The dynamic characteristics (or dynamic characteristic values, dynamic parameters) can be, for example, start, end, local maxima, local minima, local velocities, deflections and/or amplitudes of touch events or a set of touch events.

The entirety of the dynamic characteristics characterizing the periodic signal can preferably be combined in a data set which can be compared with a reference data set to identify or verify the applied electrical structure. In a preferred embodiment, the matching of the data set takes place using a machine learning model (artificial neural networks) previously created from recordings or calibration data. For example, reference data can be generated to this end by placing the device with a known electrical structure on a surface sensor and moving it substantially in the direction of a row or column of the surface sensor.

The term reference data preferably includes threshold values or reference data sets. The term reference data preferably refers to all data that allow an assignment of a detected periodic signal to an identification code or a known electrical structure.

Preferably, the reference data may be stored on a computer-usable or computer-readable medium on the data processing unit. Any file format used in the industry may be suitable. The reference data may be stored in a separate file and/or integrated in the software (e.g., in the source code).

Due to the complexity of the periodic signal, such an assignment or identification is particularly secure and protected against manipulation.

The identification methods known in the prior art are based in particular on the recognition of static signals from an electrical structure, for example a touch structure, which imitates the touch of fingertips. With sufficient skill, it is in principle possible to reproduce such touch structures with the fingers using the known methods or systems.

A reproduction of a periodic signal generated according to the invention is not possible without providing an identical electrical structure. Even if it were possible to reproduce the generation of initial touch events at one point in time by skillfully placing fingers or other capacitive structures, it would not be possible to guide the fingers in such a way that a periodic signal can be generated.

Rather, the fingers would be detected as a touch move when contact is maintained and their signals would not oscillate back and forth in correlation with the periodicity of the electrode grid.

Based on the determination of dynamic characteristics, the software can also perform a series of plausibility checks to rule out any manipulation of the signal.

For example, it may be preferred that the software evaluates the time course of the periodic signal and compares it with reference data to estimate the probability that guiding a structure by means of the input signal will result in the detected time course of the dynamic signals.

In particularly preferred embodiments, the software can evaluate dynamic characteristics of the periodic signal, such as its period length, amplitude and/or period duration, and compare them with reference data. As explained above, the period length, amplitude and/or period duration are particularly suitable parameters to characterize the periodic signal and its underlying electrical structure. As a plausibility criterion, the period length should, for example, preferably correlate with the grid constants of the electrode grid.

The determination of the dynamic characteristics of the periodic signal and the comparison with threshold values and/or reference data sets thus preferably allows both a verification of the plausibility of the signal and its assignment to reference data for identification purposes. The evaluation by means of the software can be implemented in various ways and comprise several steps. Preferably, the device parameters of the apparatus containing the surface sensor, e.g. the resolution of the surface sensor or touch screen, can be determined first.

Hereby, the periodic signal comprising a set of touch events is preferably pre-filtered and specific characteristics of the signal are amplified or adapted. Advantageously, the software is thus not limited to a specific device type, but can provide optimal results for different electronic devices or apparatuses.

After filtering the periodic signal, the signal can be verified for plausibility by calculating parameters such as a temporal course of the signal, speed and data density. Based on a comparison with known or calibrated threshold values, any manipulation can thus be reliably excluded.

Preferably, a series of diverse characteristics and parameters of the signals are then determined or calculated. For this purpose, among others, the characteristics start of the signal, end of the signal, local maxima and minima, local velocities of the signal, displacement, amplitudes, period length of periodic signals can be determined and, if necessary, transferred with further characteristics on the periodic signal into a data set. In particular, the dynamic characteristics should be suitable to characterize the oscillation of the generated periodic touch events. Subsequently, the obtained data set can be compared with a reference data set, for example located in a database, in order to decode the periodic signal, preferably using a machine learning algorithm. Decoding preferably means an assignment of the periodic signal to a known identification code or a known electrically conductive structure. In another aspect, the invention further relates to a kit for generating and evaluating a periodic signal on a capacitive surface sensor having an electrode grid comprising rows and columns comprising
a. a device which is a three-dimensional object, the three-dimensional object having a contact surface, wherein an electrically conductive structure is present at least on the contact surface of the three-dimensional object, and wherein the electrically conductive structure is arranged such that, upon movement of the device relative to the surface sensor substantially along the direction of a row or a column of the electrode grid, a periodic signal is generated which oscillates orthogonally to the movement of the device
b. a software (‘app’) for installation on a device comprising the surface sensor, which comprises commands to determine dynamic characteristics of the periodic signal and to compare them with reference data.

Optionally, the kit may further include instructions for moving the device relative to the surface sensor substantially along the direction of a row or column such that a periodic signal is generated that oscillates orthogonally to the movement of the device.

In another aspect, the invention relates to the use of the proposed device for generating a periodic signal on a capacitive surface sensor, wherein the electrically conductive structure of the device is brought into operative contact with the capacitive surface sensor and the device is moved relative to the capacitive surface sensor.

In another aspect, the invention relates to a method for generating a periodic signal on a surface sensor comprising the following steps:
a) Providing a system described comprising a device having an electrically conductive structure and a capacitive surface sensor having an electrode grid comprising rows and columns,
b) Moving the device relative to the capacitive surface sensor substantially along a row or column while the electrically conductive structure is in operative contact with the surface sensor.

The skilled person will recognize that preferred embodiments and advantages disclosed in connection with the described device, system, kit or use thereof apply equally to the other claimed categories such as the device, system, kit or use thereof. For example, preferred embodiments of the system or kit use preferred embodiments of the device and result in the same advantages.

It is preferred in the sense of the invention that the electrically conductive structure be applied to a substrate material by means of foil transfer methods, for example cold foil transfer, hot stamping and/or thermal transfer, without being limited to these application methods. In particular, printing methods, for example offset printing, gravure printing, flexographic printing, screen printing, and/or inkjet methods may be used to produce the electrically conductive structure on the non-conductive substrate without being limited thereto. Suitable electrically conductive inks include materials based on, for example, metal particles, nanoparticles, carbon, graphene, and/or electrically conductive polymers without being limited to these materials. It may also be preferred in the spirit of the invention to cover the electrically conductive structure by at least one further layer, which may be a paper- or film-based laminate material or at least one paint/lacquer layer. The layer may be optically transparent or opaque. It may be further preferred in the sense of the invention that the electrically conductive structure is applied to the inner side of a side surface of the object, for example to the inner side of the contact surface or underside of a folding box.

One feature of classic conventional printing processes is the simple and fast reproduction of a motif by applying the motif to be printed to a printing plate, for example an intaglio cylinder or an offset printing plate, which can then be reproduced several times at high speed. Conventional printing processes are not suitable for producing individualized content, as printing form production represents a significant proportion of the total production costs. This means that only large runs of a print product can be produced economically. In graphic printing, digital printing processes exist for the production of short runs as well as individualized products, with which individualized content can be printed economically. These printing processes include electrophotography, laser printing or inkjet printing, for example. It is also possible to produce individualized electrically conductive structures using process combinations of conventional printing processes and additive or subtractive processes.

Further advantages, features and details of the invention are to be taken from the further dependent claims and the following description. Features mentioned can be relevant to to the invention individually or in any combination. Thus, the disclosure relating to the individual aspects of the invention can always be referred to reciprocally. The drawings serve merely by way of example to clarify the invention and have no restrictive character.

The invention is described in more detail with reference to the following figures:

FIGS. 1a-c illustrate a device (10) for generating a periodic signal (40) on a capacitive surface sensor (20), the device (10) comprising an electrically conductive structure (12) disposed on a non-conductive substrate (14). The device (10) in the illustrated embodiment is a three-dimensional object, wherein the three-dimensional object has a contact surface (50), wherein the electrically conductive structure (12) is present arranged on the contact surface or bottom surface (50) of the three-dimensional object and determines the course of the periodic signal (40).

FIG. 1b shows the device (10) comprising an electrically conductive structure (12) on an electrically non-conductive substrate (14) that is moved in a relative motion (30) over the capacitive surface sensor (20). In the present example, the device (10) is moved in the y-direction over the capacitive surface sensor (20). For clarity, the device (10) or the bottom surface (50) of the object (10) is shown in plan view. The capacitive surface sensor (20) is part of an electronic apparatus (22), for example a smartphone or tablet. In this case, the capacitive surface sensor (20) is a touchscreen that can be characterized via x and y coordinates.

FIG. 1c shows the periodic signal (40) on the capacitive surface sensor (20). In the exemplary embodiment, a periodic signal (40) is generated by each of the left and right regions of the electrically conductive structure (12). The periodic signals (40) are non-harmonic signals corresponding to the direction of movement of the device (10) in the direction of the y-axis. The right-hand one of the two position-dependent signals has a loop-shaped course. In other words, the electrically conductive structure (12) is arranged to periodically increase and decrease the y-coordinate of the signal (40) in the direction of which the device (10) is moved across the capacitive surface sensor (20), even though the device (10) is moved steadily in one direction across the capacitive surface sensor (20), i.e., the periodic signal (40) is “fed back and forward again” at periodic or cyclic intervals.

For clarity of presentation, the periodic signals (40) are represented as if they had been recorded on the capacitive surface sensor (20) over the period of relative movement (30) of the device (10), i.e., the touch inputs on the capacitive surface sensor (20) were detected, recorded, and displayed on the touchscreen. In the following, this signal displayed on the touch screen is referred to as a “recorded periodic signal” (40). A person skilled in the art understands that the signal (40) is gradually generated during the relative movement (30) of the device (10) via the capacitive surface sensor (20). As soon as the device (10) has been moved over an area of the surface sensor (20), no signal (40) can be detected at this point, i.e. the touchscreen is no longer “activated” at this point.

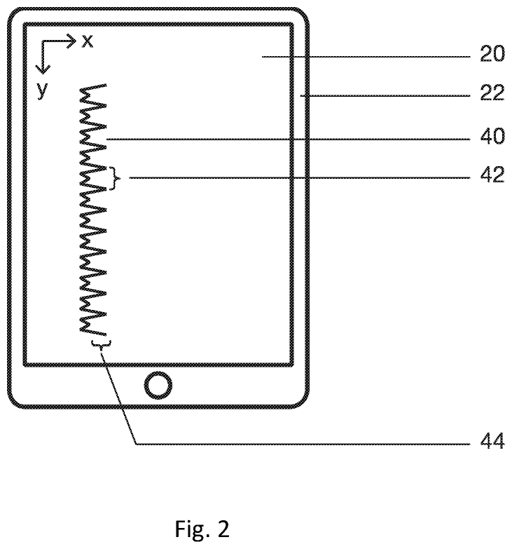

FIG. 2 shows the recorded periodic signal (40) on the capacitive surface sensor (20), which is part of an electronic apparatus (22). The periodic signal (40) is characterized by the period length (42) and the amplitude (44). The period length (42) is, in the case of the periodically repeating signal (40), the smallest local interval after which the process repeats. The amplitude (44) is the maximum deflection of the periodic signal (40) from the position of the arithmetic mean of the signal.

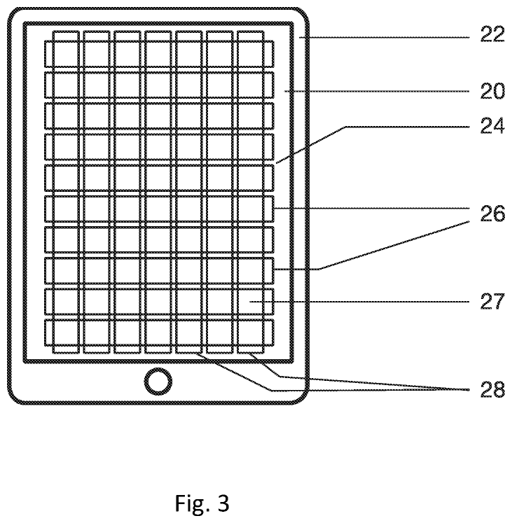

FIG. 3 shows the electronic apparatus (22) that includes the capacitive surface sensor (20). The surface sensor (20) has an electrode grid (24) that includes rows (26) and columns (28). At each location where a row (26) and a column (28) of the electrode grid (24) overlap, there is an electrode intersection (27), which is shown hatched at a location in the drawing for clarity. Rows (26) and columns (28) generally represent transmitting and receiving electrodes of the capacitive surface sensor (20).

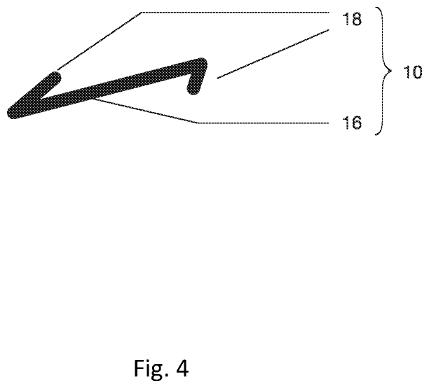

FIG. 4 shows a preferred embodiment of the electrically conductive structure (12). The electrically conductive structure (12) can be characterized by the design of the main element (16) and the design of the sub-elements (18). For the purposes of the invention, the term design includes, but is not limited to, the shape, size, geometry, length, width, orientation, position and angle of the elements of the electrically conductive structure (12). For example, in the depicted embodiment, the main element (16) has a linear shape with a length of 45 mm and a width of 2 mm. The main element (16) is at an angle of 20° on the device (not shown). The left sub-element (18) is also of linear shape, has a length of 13 mm and a width of 2 mm, and lies at an angle of 40°. The right sub-element (18) is also linear, has a length of 6 mm and a width of 2 mm and is at an angle of 70°. Both sub-elements (18) are galvanically connected to the main element (16) and together with the main element (16) form the electrically conductive structure (12) in its entirety.

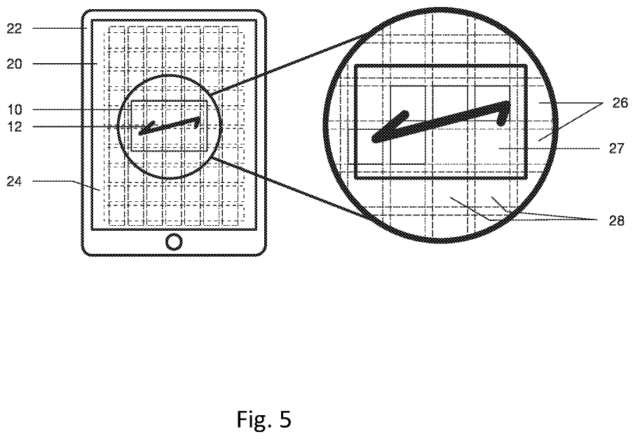

FIG. 5, left, shows the device (10) comprising an electrically conductive structure (12) on the capacitive surface sensor (20). The electrically conductive structure (12) interacts with the electrode grid (24) of the capacitive surface sensor (20). On the right side of the figure, a detail magnification is shown in which the electrode intersections (27) interacting with the electrically conductive structure (12) are shown hatched. As the device (10) comprising the electrically conductive structure (12) is moved across the electrode grid (24) of the capacitive surface sensor (20), the electrically conductive structure (12) progressively interacts with other electrode intersections (27). It is preferred that the electrically conductive structure (12) interacts with at least two rows (26) and at least two columns (28) at any time during the movement (30).

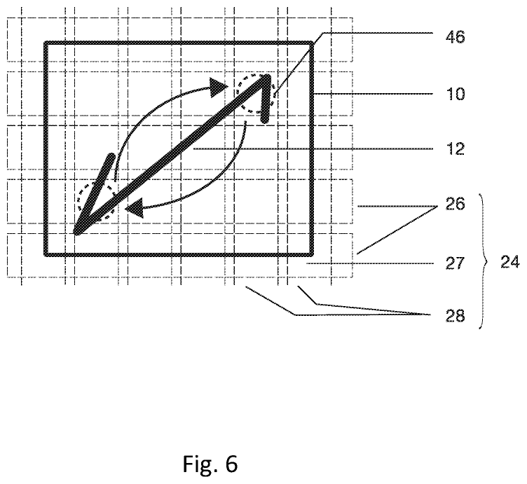

FIG. 6 shows a preferred embodiment of the electrically conductive structure (12) arranged on the electrode grid (24) of the capacitive surface sensor (shown only as a section). The touch events (46) generated by the electrically conductive structure (12) are shown by dashed circles at the corresponding electrode intersections (27). In the present embodiment, the electrically conductive structure (12) bridges a distance between two electrode intersections (27). Placing the electrically conductive structure (12) on the electrode grid (24) preferably creates a capacitive connection between at least two different electrode intersections, which is in particular established and maintained by the electrically conductive structure (12). The electrically conductive structure (12) interacts capacitively with the electrode grid (24). It is preferred in the sense of the invention that the electrically conductive structure (12) interconnects the columns (28) and rows (26) of the electrode grid (24) of the surface sensor (20), so that an interaction between the at least four electrodes concerned (two transmitting electrodes and two receiving electrodes) is caused here. The interaction between the electrodes is shown by arrows. FIG. 7 shows different states when moving the device (10) comprising the electrically conductive structure (12) over the capacitive surface sensor (20) or the electrode grid (24). The rows (26) of the electrode grid (24) are numbered for ease of reference. A total of 5 states are shown t1, t2, t3, . . . , tx and tx+1. On the individual graphics t2, t3 and tx, the arrow indicates the movement of the device (10) or the electrically conductive structure (12) relative to the electrode grid (24). On the respective individual graphs, the touch events (46) generated at the respective time point are represented by dashed circles. The touch events generated at a previous time point are shown with simple circles. The circles have been connected by lines to clarify the temporal sequence. The entirety of touch events (46) generated over the time course t1 to tx+1 result in the recorded periodic signal (40). Depending on the overlap of the electrically conductive structure (12), the touch events (46) occur at specific electrode intersections (24). A touch event (46) is generated when the respective electrode intersection (27) of the underlying electrode grid (24) is covered or overlapped by a minimum area of the electrically conductive structure (12). This minimum area is preferably >20% of the area of an electrode intersection and particularly preferably >30% of the area of an electrode intersection. Due to the overlapping of the electrically conductive structure with the electrode grid, the left part of the periodic signal (40) in this example has a zigzag shape. In this case, the period length of the signal corresponds to the grid constant of the electrode grid (24).

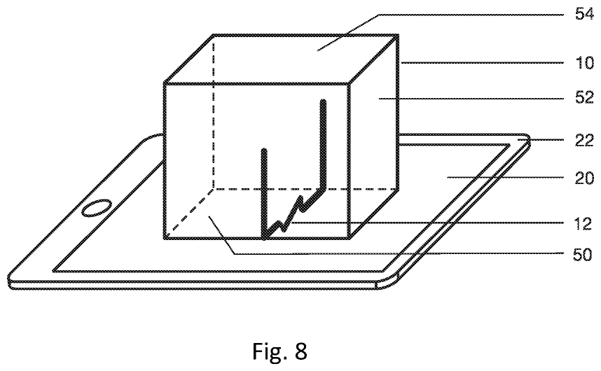

FIG. 8 shows the device (10) in the form of a three-dimensional object on a capacitive surface sensor (20), which is part of an electronic device (22). The device (10) comprises an electrically conductive structure (12) arranged on the bottom or contact side (50) and on two side surfaces (52) of the object. This portion of the electrically conductive structure (12) may be referred to as the contact surface or touch surface.

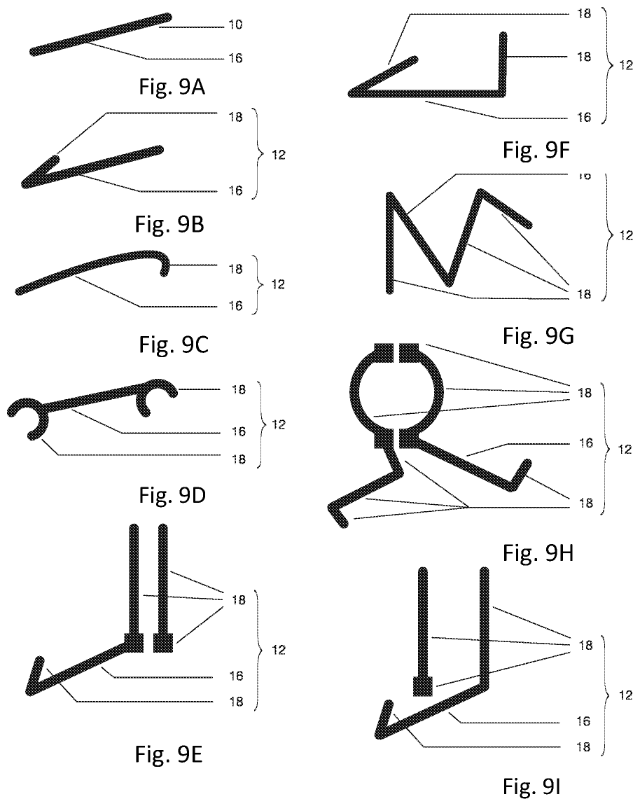

FIG. 9 shows further embodiments of the electrically conductive structure (12), which differ in particular with regard to the design of the main element (16) and the sub-elements (18). For example, there may be a smooth transition between the main element (16) and the sub-element (18), as shown in the center left example. Furthermore, it may be preferred to attach a sub-element (18) not directly to the main element (16), but to another sub-element (18), as shown in the center right example. The main elements (16) and/or sub-elements (18) may have the shape of arc. In further preferred embodiments (shown in the diagram below), the electrically conductive structure (12) may comprise two regions separated from each other. The resulting periodic signals (40) on the capacitive surface sensor (20) are correspondingly more complex. The number, arrangement and orientation of the main elements (16) and sub-elements (18) are not limited to the embodiments shown.

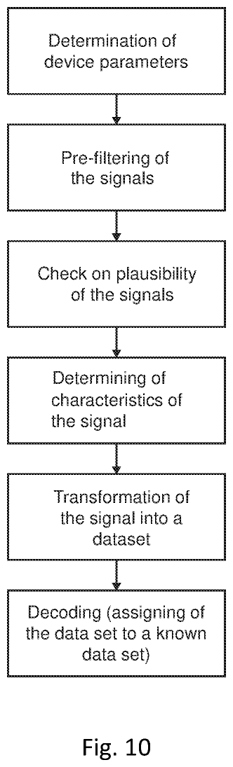

FIG. 10 shows the steps of processing and evaluating the touch events or touches with the help of a software program. Preferably, the device parameters of the device containing the surface sensor, e.g. the resolution of the touch screen, are determined first. Depending on the device, the signal comprising a set of touch events is preferably pre-filtered in the next step and specific characteristics of the signal are amplified or adjusted. Subsequently, the signal is checked for plausibility by calculating characteristics or parameters such as temporal course of the signal, velocity and data density and checking them for possible manipulation and comparing them with known reference values. It is preferred that subsequently various characteristics and parameters of the signal are determined or calculated, including the characteristic values start of the signal, end of the signal, local maxima and minima, local velocities of the signal, displacement, amplitudes, period length of periodic signals and possibly other characteristics, in order to convert the signal into a comparable data set. In particular, it is preferred to subsequently compare this data set with other data sets and to assign it to a known data set located, for example, in a database, and thus to decode the signal. In a further preferred embodiment, the matching of the data set takes place using a machine learning model (artificial neural networks) previously created from recordings. In particular, it was surprising that the use of a machine learning model to decode the signal is particularly suitable for complex signals with many different parameters.

### LIST OF REFERENCE SIGNS

10 Device or three-dimensional object
12 Electrically conductive structure
14 Electrically non-conductive substrate
16 Main element of the electrically conductive structure
18 Sub-element of the electrically conductive structure
20 Surface sensor
22 Apparatus or device containing a surface sensor
24 Electrode grid of the surface sensor
26 Rows of the electrode grid
27 Intersections between rows and columns of the electrode grid
28 Columns of the electrode grid
30 Relative movement between device (10) and surface sensor (20)
40 Periodic signal
42 Period length of the periodic signal
44 Amplitude of the periodic signal
46 Touch event
50 Contact surface (bottom surface)
52 Side surface
54 Top surface

1. System for generating a periodic signal (40) on a capacitive surface sensor (20), the system comprising a device (10) and an apparatus (22) having a capacitive surface sensor (20) characterized in that
a) the device (10) is a three-dimensional object, the three-dimensional object having a contact surface (50), wherein an electrically conductive structure (12) is disposed at least on the contact surface (50) of the three-dimensional object
b) the capacitive surface sensor (20) has an electrode grid (24) comprising rows (26) and columns (28),
and wherein the electrically conductive structure (12) is arranged such that upon movement of the device (10) relative to the surface sensor (20) substantially along the direction of a row (26) or a column (28) of the electrode grid (24), a periodic signal (40) is generated which oscillates orthogonally to the movement of the device (10).

2. System according to the previous claim, characterized in that
the period length (42) of the periodic signal (40) correlates with the grid constant of the electrode grid (24) in the capacitive surface sensor (20).

3. System according to claim 1 or 2, characterized in that
the period length (42) of the periodic signal (40) is at least 2 mm, preferably at least 3 mm and particularly preferably at least 4 mm, and/or is at most 9 mm, preferably at most 7 mm and particularly preferably at most 5 mm.

4. System according to one or more of the preceding claims, characterized in that
the amplitude (44) of the periodic signal (40) is at least 1 mm, preferably at least 2 mm and particularly preferably at least 3 mm and/or preferably at most 60 mm and particularly preferably at most 40 mm.

5. System according to one or more of the preceding claims, characterized in that
the electrically conductive structure (12) is arranged to define a course of the periodic signal (40) on the capacitive surface sensor (20) with respect to a curve shape, an amplitude (44) and/or an edge shape.

6. System according to one or more of the preceding claims, characterized in that
the duration of the periodic signal (40) is at least 250 ms, preferably at least 500 ms and particularly preferably at least 750 ms.

7. System according to one or more of the preceding claims, characterized in that
the electrically conductive structure (12) is adapted to interact with at least two rows (26) and at least two columns (28) of an electrode grid (24) of the capacitive surface sensor (20).

8. System according to one or more of the preceding claims, characterized in that
the electrically conductive structure (12) comprises at least two sub-regions having two centroids, which are arranged to generate a touch event in case of overlap with an intersection of the electrode grid (24) and not to generate a touch event in case of no overlap with an intersection of the electrode grid (24), so that upon relative movement of the device (10) substantially along a row or column of the electrode grid (24), a periodic signal (40) is generated by alternately generating a touch event upon alternate superposition of the first or second centroid with intersections of the electrode grid.

9. System according to one or more of the preceding claims, characterized in that
the electrically conductive structure (12) has at least two sub-regions which, depending on the positioning on the electrode grid (24), cover a minimum area of more than 20%, preferably more than 30%, and/or a maximum area of less than 70%, preferably less than 50%, of the area of an underlying electrode intersection.

10. System (10) according to one or more of the preceding claims, characterized in that
a course of the periodic signal (40) is determined by the interaction of sub-regions of the electrically conductive structure (12) with the electrode grid (24) of the capacitive surface sensor (20).

11. System according to one or more of the preceding claims, characterized in that
the system has a data processing device which is adapted to evaluate the periodic signal (40), the data processing device preferably having installed on it software (‘app’) which comprises commands to evaluate dynamic characteristics of the periodic signal (40) and to compare them with reference data.

12. System according to the previous claim characterized in that
the dynamic characteristics comprise a period length (42), an amplitude (44) and/or a period duration.

13. System according to one or more of claim 11 or 12 characterized in that
the device (22) including the surface sensor (20) processes the periodic signal as a set of touch events, and software determines dynamic characteristics of the set of touch events.

14. System according to one or more of claims 11-13 characterized in that
the dynamic characteristics comprise start, end, local maxima, local minima, velocities, deflections and/or amplitudes of the touch events.

15. Device for generating a periodic signal (40) on a capacitive surface sensor (20) having an electrode grid (24) comprising rows (26) and columns (28), characterized in that
the device (10) is a three-dimensional object, wherein the three-dimensional object has a contact surface (50), wherein an electrically conductive structure (12) is present at least on the contact surface (50) of the three-dimensional object, and wherein the electrically conductive structure (12) is arranged such that upon a movement of the device (10) relative to the surface sensor (20) substantially along the direction of a row (26) or a column (28) of the electrode grid (24), a periodic signal (40) is generated which oscillates orthogonally to the movement of the device (10).

16. Device according to the previous claim characterized in that
the electrically conductive structure (12) has a linear shape whose width is 0.5 mm to 8 mm, preferably 1.5 mm to 5 mm.

17. Device according to any one of the preceding claim 15 or 16 characterized in that
the electrically conductive structure (12) comprises at least one line-shaped main element (16) and at least one line-shaped sub-element (18), wherein the main element (16) and the subelement (18) are galvanically connected to each other and preferably enclose an angle of 10° to 80°, more preferably 20° to 60°.

18. Device according to any one of the preceding claims 15-17 characterized in that
he contact surface (50) has a substantially rectangular shape and the main element (16) has an angle of 5° to 45°, preferably 10° to 35° to one of the two edges of the contact surface (50).

19. Device according to any one of the preceding claims 15-18 characterized in that
the electrically conductive structure (12) is arranged on a non-conductive substrate (14).

20. Device according to any one of the preceding claims 15-19, characterized in that
the electrically conductive structure (12) is present on the contact surface (50) and on at least one side surface (52) of the device (10).

21. Device (10) according to any one of the preceding claims 15-20, characterized in that
the device (10) is a package or a folding box.

22. Device (10) according to any one of the preceding claims 15-21, characterized in that
the device (10) is card-shaped object.

23. Use of the device (10) according to one or more of claims 15 to 22 for generating a periodic signal (40) on a capacitive surface sensor (20) having an electrode grid comprising rows (26) and columns (28) characterized in that
the electrically conductive structure (12) of the device (10) is brought into operative contact with the capacitive surface sensor (20) and the device (10) is moved substantially along a row or column relative to the capacitive surface sensor (20).

24. A kit for generating and evaluating a periodic signal (40) on a capacitive surface sensor (20) having an electrode grid (24) with rows (26) and columns (28) comprising
a) a device (10) which is a three-dimensional object, wherein the three-dimensional object has a contact surface (50), wherein an electrically conductive structure (12) is present at least on the contact surface (50) of the three-dimensional object, and wherein the electrically conductive structure (12) is arranged in such a way that upon a movement of the device (10) relative to the surface sensor (20) substantially along the direction of a row (26) or a column (28) of the electrode grid (24), a periodic signal (40) is generated which oscillates orthogonally to the movement of the device (10)
b) software ('app') for installation on a device (22) comprising the surface sensor (20), which comprises commands to determine dynamic characteristics of the periodic signal (40) and to compare them with reference data.

25. A method of generating a periodic signal on a surface sensor (20) comprising the following steps:
a) Providing a system according to any one of claims 1-14 comprising a device (10) having an electrically conductive structure (12) and an apparatus having a capacitive surface sensor (20) having an electrode grid (24) comprising rows (26) and columns (28),
b) Moving the device (10) relative to the capacitive surface sensor (20) substantially along a row (26) or column (28) while the electrically conductive structure (12) is in operative contact with the surface sensor (20).
